(19) United States
(12) Patent Application Publication
(10) Pub. No.: US 2007/0146957 A1
(43) Pub. Date: Jun. 28, 2007

(54) Current inductive timer socket

(75) Inventor: Wan-Chiar Chen, Kaohsiung City (TW)

Correspondence Address: CHARLES E. BAXLEY, ESQ., 90 JOHN STREET, THIRD FLOOR, NEW YORK, NY, 10038, US

(73) Assignee: Dinjoker Co., Ltd.

(21) Appl. No.: 11/317,445

(22) Filed: Dec. 24, 2005

(51) Int. Cl. H01H 47/00

(52) U.S. Cl. 361/160

(57) ABSTRACT

A current inductive timer socket comprises: a principle relay circuit including an output relay and a voltage input terminal, a reed relay circuit including a capacitor, a plurality of diodes, a reed relay and a resistance, a counter circuit including a DC rectifier, seven series-connected counters, and a time select switch, a holding circuit including a neon light, a photodiode, an operational amplifier, a transistor, a diode and a resistance, a time switch circuit including three time switches, and three series-connected exciting transistors, and an inductive and amplification circuit including a transformer parallel-connected to a rated resistor, a set of two-stage operational amplifiers, a resistance, and a capacitor. When the electric appliance is in use, a signal of voltage drop produced at both ends of the rated resistance will be amplified by the operational amplifier and then transmitted to the counter circuit, making the counter circuit start to count automatically, and thus time operation is carried out.

### BACKGROUND OF THE INVENTION

1. Field of the Invention

The present invention relates to a timer socket, and more particularly to a current inductive timer socket, when an electric appliance starts to operate, current will flow through the timer of the current inductive timer socket, turning on the timer and making it start to count, and after the timer counts to a predetermined value, it will cut off the power supply to the electric appliance.

2. Description of the Prior Art

Some people always forget to turn off the electric appliances after use, for example, forgetting to turn off the electric iron after ironing, this is not only power consuming but also the hot iron is likely to ignite the furniture, causing fire. Although the electric appliances may have a timer, if the user forgets to set it, the electric appliances will not be turned off automatically.

The present invention has arisen to mitigate and/or obviate the afore-described disadvantages.

### SUMMARY OF THE INVENTION

To solve the abovementioned problems, the present invention provides a timer socket that can carry out a timing operation automatically by sensing the working status of the electric appliance, that is, as long as the electric appliance connected to the timer socket is switched on, the timer inside the timer socket will starts counting automatically, and after counting to a predetermined value, it will cut off the power supply to the electric appliance, ensuring that the electric appliance can be used safely. This timer socket can provide a timing function for those electric appliances without timing function, and can remedy the shortcomings of the electric appliances with timing function. Because people usually forget to set the timer of the appliances during use, so that the electric appliances may keep turning on after use, wasting power or even causing fire.

The current inductive timer socket provided in accordance with the present invention comprises: a principle relay circuit, a reed relay circuit, a counter circuit, a holding circuit, a time switch circuit, an inductive and amplification circuit, a household electric appliance socket, and a second timer socket. The principle relay circuit 1 includes two voltage input terminals A, B, and an inductive output relay having three contact points: C, NC and NO. The voltage input terminal, under the control of the output relay, outputs power to the household electric appliance socket or to the second current inductive timer socket. The reed relay circuit includes a capacitor, a plurality of diodes, a reed relay and a resistance, and is used to receive signals from exciting transistors of a time switch circuit, and to start the output relay. The counter circuit includes a DC rectifier, seven series-connected counters, and a time select switch. The holding circuit, when the set time is up, the output relay will be started, and the common point of the output relay will be disconnected from the normal contact point. Therefore, a voltage will be produced between the common point and the normal contact point, and the voltage will then turn on the neon light, illuminating the photodiode 2, so that the reed relay will be kept turning on. The time switch circuit includes three time switches, and three series-connected exciting transistors, and the time units of the three time switches are minute, ten minute and hour. The inductive and amplification circuit includes a transformer parallel-connected to a rated resistor and a set of two-stage operational amplifiers. With the abovementioned circuits, during use of an electric appliance, a signal of voltage drop will be produced at both ends of the rated resistance, and then will be amplified by the operational amplifier and transmitted to the counter circuit, making the counter circuit start to count automatically, and thus time operation is carried out.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a block diagram of showing a control circuit of a current inductive timer socket in accordance with the present invention;

FIG. 2 is a circuit diagram of showing the control circuit a current inductive timer socket in accordance with the present invention;

FIG. 3 is an enlarged view of a part of the control circuit a current inductive timer socket in accordance with the present invention; and

FIG. 4 shows the current inductive timer socket in accordance with the present invention.

### DETAILED DESCRIPTION OF THE PREFERRED EMBODIMENTS

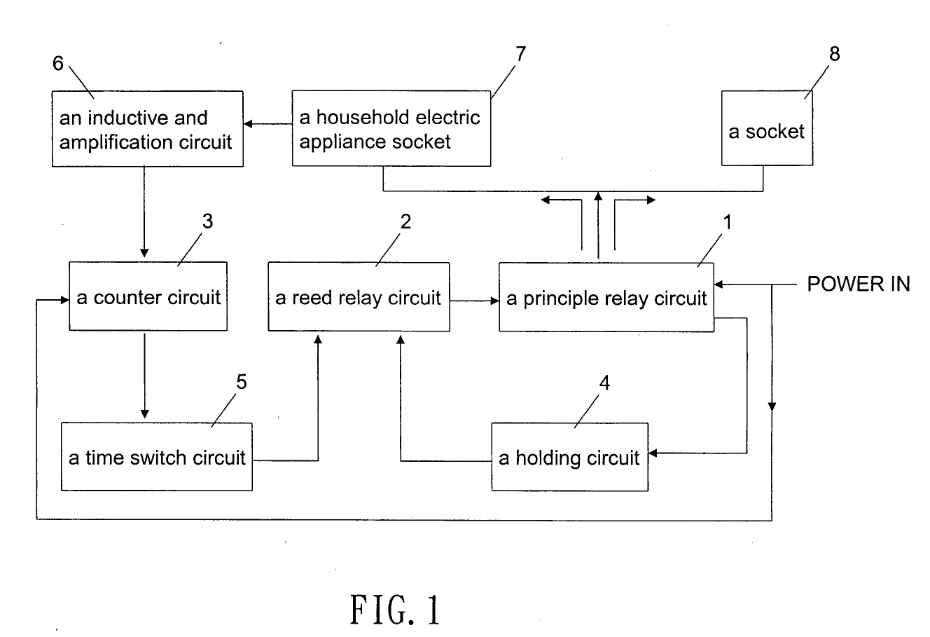

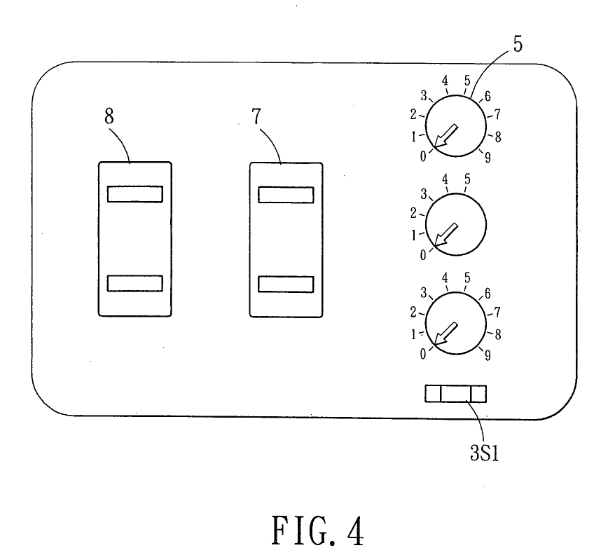

Referring to FIGS. 1-4, a current inductive timer socket in accordance with the present invention is illustrated and comprises a principle relay circuit 1, a reed relay circuit 2, a counter circuit 3, a holding circuit 4, a time switch circuit 5, an inductive and amplification circuit 6, a household electric appliance socket 7, and a socket 8 for connection of another current inductive timer socket. The principle relay circuit 1 includes two voltage input terminals A, B, and an inductive output relay having three contact points: C, NC and NO. The output relay is used to control the power transmitted to the household electric appliance socket 7 and the socket 8. Therefore, the present invention allows a plurality of current inductive timer sockets to be connected in series, and each of the current inductive timer sockets is then connected in series to electric equipments. The current inductive timer sockets are set differently so that the electric equipments can be controlled to work according to the predetermined program.

The reed relay circuit 2 includes a rectifying and filtering capacitor 2C, two diodes D1, D2, a reed relay 21, and a resistance 2R. The reed relay circuit 2 is used to receive the signal from the exciting transistors Tr1, Tr2 and Tr3 of the time switch circuit 5, and to start the output relay 11. The counter circuit 3 includes a DC rectifier, an inverter 3C9, and seven series-connected counters 3C1-3C7 that are senary, decimal, senary, decimal, decimal, senary and decimal. The counter 3C1 has an input terminal P, and the counter 3C3 has an input terminal Q. When a time select switch 3S1 is started, current will flow from the inverter 3C9 to the point P, the set time is at the most 9 hours and 59 minutes. When the current flows from inverter 3C9 to the point Q, the set time is no more than 9 minutes and 59 seconds. The holding circuit 4 plays an important role when the electric appliance is in use, when the set time is up, the output relay 11 will be started, and the common point C of the output relay 11 will be disconnected from the normal contact point NC. The common point C is connected to the power source point A, the normal contact point NC will be connected to the household appliance socket 7 via a rated resistance RM, and finally will be connected to the power source point B after passing through the inner circuit of the electric appliance (when the electric appliance is in use, its inner circuit is turned on). Therefore, a voltage will be produced between the common point C and the normal contact point NC. The voltage will then turn on the neon light 41, illuminating the photodiode 42, so that the reed relay 21 will be kept on, the output relay 11 also will be kept on, and thus the set time is up, turning off the electric appliance. Therefore, the holding circuit 4 includes the neon light 41, the photodiode 42, an operational amplifier OP3, a transistor Tr4, a diode D4 and a resistance 4R.

The time switch circuit 5 includes three time switches 5S1, 5S2 and 5S3, and three series-connected exciting Transistors Tr1, Tr2 and Tr3, and the time units of the time switches 5S1, 5S2 and 5S3 are minute, ten minute and hour. Between the counters 3C5, 3C6, 3C7 and the minute time switch 5S1, the ten-minute time switch 5S2, the hour time switch 5S3 are connected a minute diode 5D1, a ten-minute diode 5D2 and a hour diode 5D3, so as to stabilize the signal. The time switches 5S1, 5S2 and 5S3 can be dip switch or rotary switch. The rotary switch is a “one-input ten-output and one-input six-output” element. The time select switch 3S1 has a minute's time set and an hour's time set. The inductive and amplification circuit 6 includes a transformer T parallel-connected to the rated resistor RM, a set of two-stage operational amplifiers OP1, OP2 parallel-connected to a resistance 6R, and a capacitor. The inductive and amplification circuit 6 serves to provide voltage-stabilized current for the counter circuit 3.

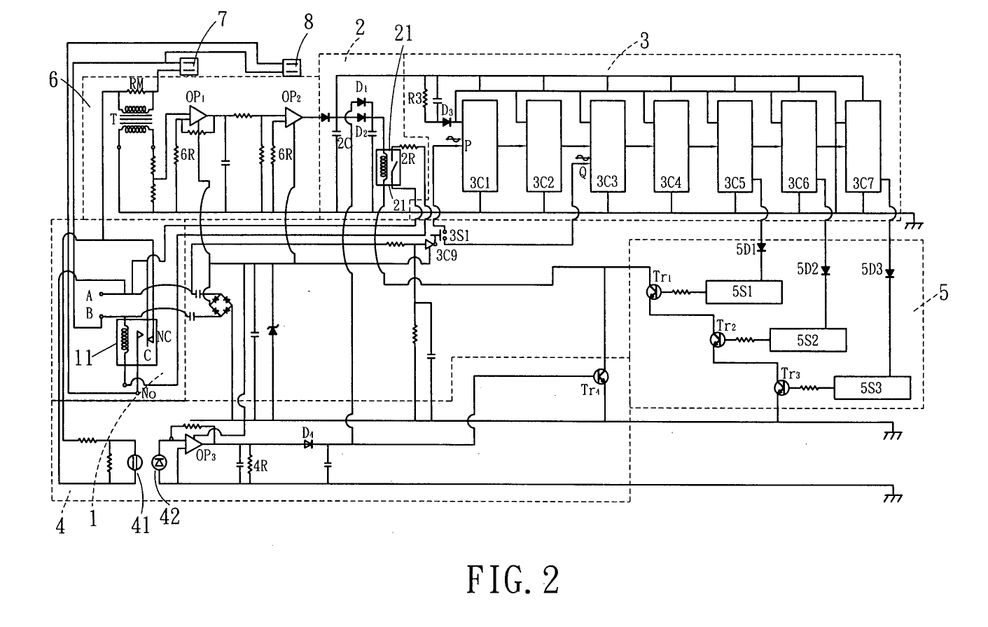

As shown in FIG. 2, after the time switches 5S1, 5S2 and 5S3 are set, and the plug of the household electric appliance is inserted in the household electric appliance socket 7, the household electric appliance can start to work. During use, current will pass through the electric appliances, for example, a 110 v, 110 w electric appliance will have 0.9 A current, and the current will also pass through the rated resistance RM, producing a voltage drop at both ends of the rated resistance RM. The minor voltage drop will be considered as a signal and then will be amplified and transmitted to the counter circuit 3, so as to start the counters 3C1-3C7. At this moment, the timer function begins to take effect. The specification of the rated resistance RM has relationship to the specification of the electric appliance. If the rated resistance RM is too great, it will produce a lot of heat, and if the rated resistance RM is too small, the counters cannot be started. If the rated resistance RM is 0.01 ohm, the power of the corresponding electric appliance should range from 30-1000 w.

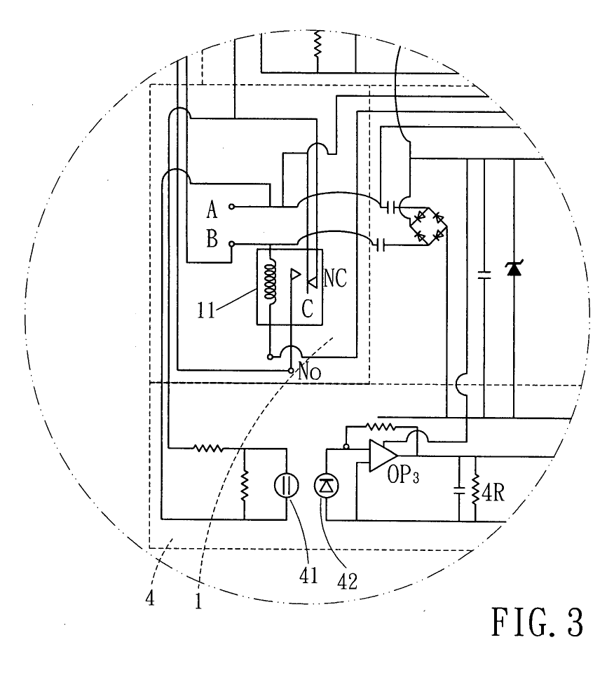

As shown in FIGS. 1 and 3, the minor voltage drop is considered as a signal that is to be amplified by the operational amplifiers OP1 and OP2, and then it will pass through a diode D3, a resistance R3 and will be transmitted to the counters 3C1-3C7, at the same time, the counters are returned to zero. After that, the counters 3C1-3C7 start to count based on the household current of 60 cycles per second. When the original preset time that set by time switches 5S1, 5S2 and 5S3 is reached, the exciting transistors Tr1, Tr2 and Tr3 of the time switch circuit 5 will enable the reed relay 21 and the output relay 11 to cut off the electric supply, thus turning off the electric appliance automatically.

During use of the electric appliance, when the set time is up, the common point C of the output relay 11 will be disconnected from the normal contact point NC. The common point C is connected to the power source point A, the normal contact point NC will be connected to the household appliance socket 7 via a rated resistance, and finally will be connected to the power source point B after passing through the inner circuit of the electric appliance (when the electric appliance is in use, its inner circuit is turned on). Therefore, a voltage will be produced between the common point C and the normal contact point NC. The voltage will then turn on the neon light 41, illuminating the photodiode 42, namely, photocoupler. The photocoupler will produce a signal voltage that will be amplified by the operational amplifier OP3 and transmitted to the transistor Tr4, enabling the reed relay 21 to keep the output relay 11 on, thus the timing operation is finished. After that, if the user turns off the switch of the electric appliance, the circuit, consisted of the normal contact NC of the output relay 11, the rated resistance RM, the household electric appliance socket 7, the inner circuit of the electric appliance and the power source point B, will be cut off. As a result, the voltage between the common point C and the normal contact point NC will disappear, and the neon light 41, the photodiode 42 and the operational amplifier OP3 will be turned off. Meanwhile, the reed relay 21 will be opened, and the output relay 11 will be restored to normal. In this way, another cycle of timing operation can start when the electric appliance is used again.

The present invention has the following advantages: during use of the electric appliance, the current passing through the electric appliance will activate the timer of the current inductive timer socket automatically. If the rotary button or key of the time is not adjusted, the set time will not be changed and needn't to be set every time, this is helpful to the forgetful user. If the electric appliance is broken or the user forgets to turn it off, the present invention can turn off the electric appliance automatically. For example, it is very dangerous if an electric cooker cannot be turned off due to the failure of its temperature-control switch. However, it will be safer and the electric cooker can be turned off automatically if it is connected to a current inductive timer socket. Furthermore, the present invention allows a plurality of current inductive timer sockets to be connected in series, and each of the current inductive timer sockets is then connected in series to electric equipments. The current inductive timer sockets are set differently so that the electric equipments can be controlled to work according to the predetermined program.

In addition, the combination of the holding circuit 4 and the reed relay circuit 2 is a linked device and can be replaced by the following devices: 1) using a photocoupler consisted of a light resistance Cds and a neon light to control a silicon control switch TRIAC, or 2) keep relay.

While we have shown and described various embodiments in accordance with the present invention, it should be clear to those skilled in the art that further embodiments may be made without departing from the scope of the present invention.

What is claimed is:

1. A current inductive timer socket comprising:
a principle relay circuit including an output relay and a voltage input terminal, the output relay controls a power transmitted from the voltage input terminal to a household electric appliance socket or a second current inductive timer socket;
a reed relay circuit including a capacitor, a plurality of diodes, a reed relay and a resistance, and being used to receive signals from exciting transistors of a time switch circuit, and to start the output relay;
a counter circuit including a DC rectifier, seven series-connected counters, and a time select switch;
a holding circuit including a neon light, a photodiode, an operational amplifier, a transistor, a diode and a resistance;
a time switch circuit including three time switches, and three series-connected exciting transistors, and the time units of the three time switches are minute, ten minute and hour;
an inductive and amplification circuit including a transformer parallel-connected to a rated resistor, a set of two-stage operational amplifiers, a resistance, and a capacitor;
a household electric appliance socket for connection of a household electric appliance;
a second current inductive timer socket for connection of another current inductive timer socket;
when an electric appliance is connected to the current inductive timer socket, a signal of voltage drop will be produced at both ends of the rated resistance, and then will be amplified by the operational amplifier and transmitted to the counter circuit, when the counter circuit counts to a predetermined value, the time switches will send signals to the three exciting transistors, so as to start the reed relay and the output relay, thus cutting off the power supply to the electric appliance, meanwhile, the holding circuit will keep the output relay on, thus a timing operation is finished, after that, if the user turns off a switch of the electric appliance, the holding circuit will make the output relay switch off, returning to its original state.

2. The current inductive timer socket as claimed in claim 1, wherein the voltage input terminal, under the control of the output relay, outputs power to the household electric appliance socket or to the second current inductive timer socket, thus a plurality of current inductive timer sockets are allowed to be connected.

3. The current inductive timer socket as claimed in claim 1, wherein the seven series-connected counters are senary, decimal, senary, decimal, decimal, senary and decimal.

4. The current inductive timer socket as claimed in claim 1, wherein a maximum set time of the counter circuit is decided by the time switches, signal is switched to an input terminal P of a counter 3C1 or an input terminal Q of a counter 3C3, for hour/minute setting or minute/second setting.

5. The current inductive timer socket as claimed in claim 1, wherein each of the time switches is in the form of a dip switch or a rotary switch.

6. The current inductive timer socket as claimed in claim 1, wherein a combination of the holding circuit and the reed relay circuit is a linked device and is replaced by the following devices: 1) using a photocoupler consisted of a light resistance Cds and a neon light to control a silicon control switch TRIAC, or 2) keep relay.
